(19) United States
(12) Patent Application Publication
(10) Pub. No.: US 2013/0144683 A1
(43) Pub. Date: Jun. 6, 2013

(54) DETERMINING RESIDENTIAL TRANSACTION PRICE INDICES BASED ON PRIOR TRANSACTION PRICES

(71) Applicants: Edgar Rappaport, Montclair, NJ (US); Christopher C. Potter, Holmdel, NJ (US); Armand Principato, Croton-On-Hudson, NY (US); Ronald B. Blitstein, Westport, CT (US)

(72) Inventors: Edgar Rappaport, Montclair, NJ (US); Christopher C. Potter, Holmdel, NJ (US); Armand Principato, Croton-On-Hudson, NY (US); Ronald B. Blitstein, Westport, CT (US)

(73) Assignee: HMVP PARTNERS, LLC, Orlando, FL (US)

(21) Appl. No.: 13/312,037

(22) Filed: Dec. 6, 2011

(51) Int. Cl. G06Q 30/02; G06Q 50/16

(52) U.S. Cl. 705/7.29

(57) ABSTRACT

A residential index valuation server is operative to determine transaction price indices for corresponding transaction price bands of residential transactions. The residential index valuation server may include a residential transaction database operative to store a plurality of residential transactions, a residential index database operative to store a plurality of transaction price indices, and a data sufficiency rules engine comprising a plurality of data sufficiency rules for evaluating the data sufficiency of residential transaction information. The residential index valuation server may aggregate a selected plurality of the residential transactions into a plurality of transaction price bands according to a plurality of residential comparable characteristics. The residential index valuation server may then determine a transaction price index for one or more of the transaction price bands. When requested by a client device, the residential index valuation server may report one or more of the transaction price indices.

### CROSS-REFERENCE TO RELATED APPLICATIONS

This application is related to U.S. patent application Ser. No. 12/459,865, filed Jul. 7, 2009, the entire disclosure of which is incorporated by reference herein.

### BACKGROUND

One of the challenges in owning or selling a residence is determining the value of the residence and determining whether the value of the residence has increased or decreased. Although residences may have comparable characteristics, the value of a residence may fluctuate over time and the value of a residence today may not be the same as the value of the residence one month later. Moreover, external factors may affect the value of the residence, such as whether other comparable residences are selling or whether other people are in the market to buy the available residences.

In addition, market volatility can affect the value of a residence. As market prices change, so does the value of the residence. During times of extreme market volatility it may be difficult for any one individual to place a value on his or her residence, let alone a value that is commensurate with similarly situated residences. Moreover, buyers are less likely to enter a given market and lenders are less likely to extend credit when there is uncertainty surrounding the value of a residence.

### BRIEF SUMMARY

An apparatus for determining transaction price indices for corresponding transaction price bands is disclosed. In one embodiment, the apparatus includes a memory operative to store a plurality of residential transactions, a plurality of transaction price indices, and a plurality of data sufficiency rules for evaluating the data sufficiency of residential transaction information. The apparatus may also include a processor operative to receive a plurality of residential transaction information evaluate the residential transaction information according to a selected one of the data sufficiency rules, and populate at least one of the residential transactions from the plurality of residential transactions with the evaluated residential transaction information. Moreover, the processor may be further operative to aggregate a selected plurality of the residential transactions into a plurality of transaction price bands according to a plurality of residential comparable characteristics, determine a transaction price index for a selected one of the plurality of transaction price bands, and report the transaction price index to a client device when the transaction price index is requested.

In another embodiment of the apparatus, the processor is further operative to determine whether a selected one of the plurality of residential transaction information was received from an authoritative source and transmit a request for additional residential transaction information when the processor determines that the selected residential transaction information was received from a non-authoritative source.

In a further embodiment of the apparatus, a selected one of the residential transactions comprises a selling price for a residence, and the transaction price index for the selected transaction price band is determined based on the selling price for the residence.

In yet another embodiment of the apparatus, a selected one of the plurality of the data sufficiency rules comprises an evaluation of whether a selected one of the plurality of residential transactions comprises complete residential transaction information.

In yet a further embodiment of the apparatus, a selected one of the plurality of the data sufficiency rules establishes a minimum set of residential transaction information expected to be received.

In another embodiment of the apparatus, the processor is further operative to determine whether the selected transaction price band comprises a threshold number of residential transactions, and expand a transaction price band limit on the selected transaction price band to include at least one additional residential transaction from another one of the plurality of transaction price bands when the selected transaction price band does not comprise the threshold number of residential transactions.

In a further embodiment of the apparatus, the processor is further operative to include additional residential transactions in the selected transaction price band when the selected transaction price band does not comprise a threshold number of residential transactions.

In yet another embodiment of the apparatus, the processor is further operative to select the additional residential transactions based on expanding a geographic scope used in previously aggregating the residential transactions into the selected transaction price band.

In yet a further embodiment of the apparatus, the residential comparable characteristics comprise at least one of demographic information, residential size, or residential location.

In another embodiment of the apparatus, the processor is further operative to re-determine the transaction price index when the processor receives additional residential transaction information that the processor determines affects the previously determined transaction price index.

A method for determining transaction price indices for corresponding transaction price bands is also disclosed. In one embodiment, the method may include establishing, in a memory, a plurality of residential transactions, a plurality of transaction price indices, and a plurality of data sufficiency rules for evaluating the data sufficiency of residential transaction information. The method may also include receiving, with a processor in communication with the memory, a plurality of residential transaction information, evaluating the residential transaction information according to a selected one of the data sufficiency rules, populating at least one of the residential transactions with the evaluated residential transaction information, and aggregating a selected plurality of the residential transactions into a plurality of transaction price bands according to a plurality of residential comparable characteristics. In addition, the method may include determining a transaction price index for a selected one of the plurality of transaction price bands, and reporting the transaction price index to a client device when the transaction price index is requested.

In another embodiment of the method, the method may include determining whether a selected one of the plurality of residential transaction information was received from an authoritative source, and transmitting a request for additional residential transaction information when the selected residential transaction information was determined to have been received from a non-authoritative source.

In a further embodiment of the method, a selected one of the residential transactions comprises a selling price for a residence, and the transaction price index for the selected transaction price band is determined based on the selling price for the residence.

In yet another embodiment of the method, a selected one of the plurality of the data sufficiency rules comprises an evaluation of whether a selected one of the plurality of residential transactions comprises complete residential transaction information.

In yet a further embodiment of the method, a selected one of the plurality of the data sufficiency rules establishes a minimum set of residential transaction information expected to be received.

In another embodiment of the method, the method may include, determining whether the selected transaction price band comprises a threshold number of residential transactions, and expanding a transaction price band limit on the selected transaction price band to include at least one additional residential transaction from another one of the plurality of transaction price bands when the selected transaction price band does not comprise the threshold number of residential transactions.

In a further embodiment of the method, the method may comprise including additional residential transactions in the selected transaction price band when the selected transaction price band does not comprise a threshold number of residential transactions.

In yet another embodiment of the method, the method may include selecting the additional residential transactions based on expanding a geographic scope used in previously aggregating the residential transactions into the selected transaction price band.

In yet a further embodiment of the method, the residential comparable characteristics comprise at least one of demographic information, residential size, or residential location.

In another embodiment of the method, the method may include re-determining the transaction price index when additional residential transaction information is received that affects the previously determined transaction price index.

Another apparatus for determining transaction price indices for a corresponding residence is also disclosed. In one embodiment, the apparatus includes a processor operative to aggregate a plurality of residential transaction prices into one or more transaction price bands, determine a first average residential transaction price for a first time period for a selected one of the one or more transaction price bands, and determine a second average residential transaction price for a second time period for the selected one of the one or more transaction price bands. The processor may also be operative to determine a residential transaction price index for the second time period based on the first average residential transaction price and the second residential transaction price, and provide the residential transaction price index when a request is received for the residential transaction price index.

### BRIEF DESCRIPTION OF THE DRAWINGS

FIG. 1 illustrates one example of a residential index valuation server in communication with sources of residential information in accordance with aspects of the disclosed embodiments.

FIG. 2 illustrates one example of a residential index valuation server from FIG. 1 in accordance with aspects of the disclosed embodiments.

FIG. 3 illustrates one example of aggregating residential transaction price records into transaction price bands in accordance with aspects of the disclosed embodiments.

FIG. 4 illustrates one example of a report illustrating residential price indices for a selected transaction price band in accordance with aspects of the disclosed embodiments.

FIGS. 5-6 illustrate one example of logic flow for determining residential transaction price indices in accordance with aspects of the disclosed embodiments.

### DETAILED DESCRIPTION

The present disclosure relates to a residential index valuation server. In particular, the present disclosure relates to a residential index valuation server operative to determine one or more residential transaction price indices for one or more residences. The one or more residential transaction price indices may indicate an objective valuation of a residence compared with similarly situated residences or residences having similar characteristics.

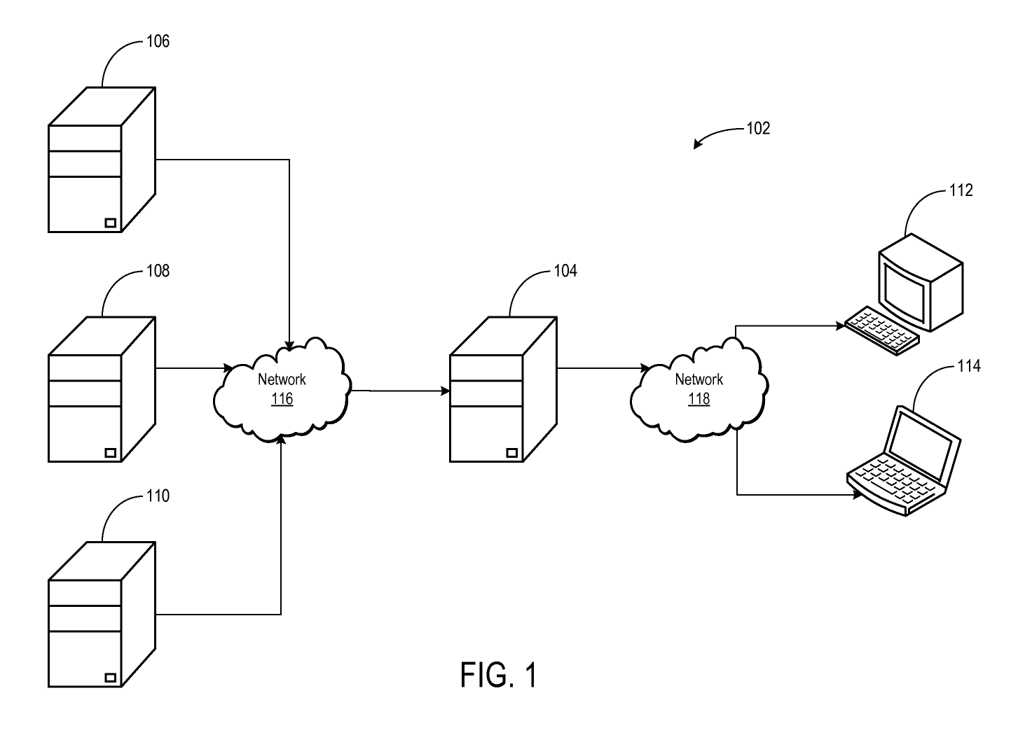

FIG. 1 illustrates one example of a system 102 in which a residential index valuation server 104 is operative to communicate with various sources of residential information 106-110. The residential index valuation server 104 may also provide transaction price indices to various client devices 112-114 based on the residential information received from the various sources of residential information 106-110.

The various sources 106-110 may provide residential information relating to transactions, such as the buying or selling, of residences. For each of the transactions involving a residence, the residential information may include information about the characteristics of the residence. For example, the residential information may include the size of the residence, the number of bathrooms in the residence, the amount of acreage included with the residence (if any), the number of bedrooms in the residence, or any other type of characteristic of a residence.

The residential information may also include the transaction details for the transaction involving the residence. Examples of transaction details may include the selling price of the residence, the purchase price of the residence, the names of the sellers of the residence, the names of the purchasers of the residence, the amount of a mortgage to purchase the residence, or any other transaction detail regarding the transaction involving the residence.

For any given transaction involving a residence, the sources of residential information 106-110 may also provide information about the geographic area near or around the residence. For example, the sources of residential information 106-110 may also provide demographic information about the area around the residence, geographic information about the location of the residence, census information about the location of the residence, or any other type of residential information. Demographic information may include the income levels for surrounding residences, the ethnicity of surrounding residences, the quality of the public school system to which the residence is assigned, or any other type of demographic information. Geographic information about the location of the residence may include the ZIP code of the residence, the lot number for the residence, the street address of the residence, the town/city in which the residence is located, the neighborhood in which the residence is located, or any other geographic information. Census information about the residence may include the population density in the area in which the residence is located, the number of children in the area in which the residence is located, the number of adults in the area in which the residence is located, or any other kind of census information about the residence.

The sources of residential information 106-110 may include various sources of residential information, such as universities, aggregators of residential information, multiple listing services, township or city clerk offices, homeowners, real estate agents, federal or state government offices, or any other providers of residential information. One example of a source of residential information is DataQuick, which has its corporate headquarters in San Diego, Calif. DataQuick may provide various types of residential information to the residential index valuation server 104 via the network 116. Another example of a source of residential information is CoreLogic, which has its corporate headquarters in Santa Ana, Calif. CoreLogic may also provide residential information to the residential index valuation server 104 via the network 116. In alternative embodiments, the residential information from DataQuick and/or CoreLogic may be provided via another communication means, such as by mail, by phone, or other such communication means.

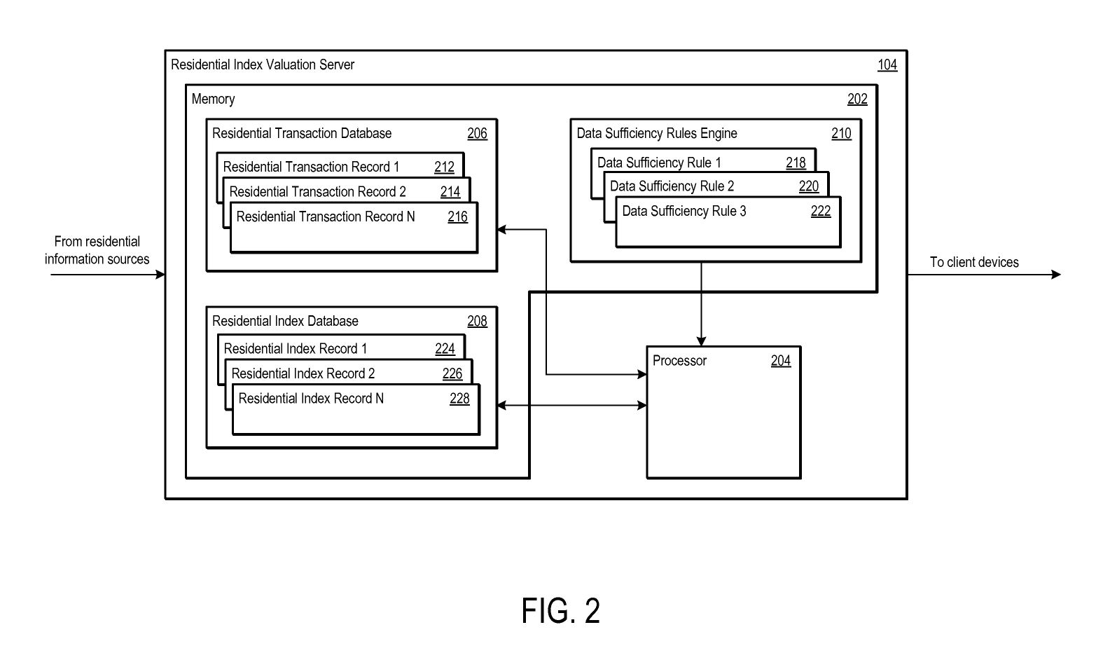

The residential index valuation server 104 may categorize the sources of residential information 106-110 into authoritative and non-authoritative sources of information. An authoritative source of residential information may be a source considered trustworthy or official. An example of an authoritative source of residential information may be a township clerk office, a designated multiple listing service, a government source of residential information, such as the U.S. Census Bureau, or other source of information considered particularly trustworthy. A non-authoritative source of residential information may be a source considered less trustworthy or non-official. Examples of non-authoritative sources of residential information include aggregators of residential information, universities, anonymous Internet users, or any other non-authoritative source. As discussed with reference to FIG. 2, categorizing the type of source of the residential information may assist the residential index valuation server in determining whether to retrieve additional information about a given residence.

As the residential index valuation server 104 is operative to provide transaction indices across many different geographies, the sources 106-110 that provide residential information, including geographic, demographic, and census information, to the residential index valuation server 104 may vary from state to state. For example, the residential index valuation server 104 may use authoritative sources for one state, such as North Carolina, but may use non-authoritative sources for another state, such as New Jersey. The residential index valuation server 104 may also use a combination of authoritative and non-authoritative sources in gathering residential information regarding residential transactions.

The client devices 112-114 may request to display one or more transaction price indices from the residential index valuation server 104. In general, the client devices 112-114 may be any type of client devices, such as a desktop computer 112, a laptop computer 114, a personal display assistant, a mobile phone, or any other type of client device.

A transaction price index may indicate the average transaction price for a residence in a particular geographic area. Moreover, a transaction price index may be determined for a particular transaction price band, such that transaction price band includes residences having similar characteristics. Increases in the transaction price index may indicate increases in the average transaction prices for residences within the transaction price band, whereas decreases in the transaction price index may indicate decreases in the average transaction prices for residences within the transaction price band. However, the converse may also be true, such that increases in the transaction price index may indicate decreases in the average transaction prices for residences within the transaction price band, whereas decreases in the transaction price index may indicate increases in the average transaction prices for residences within the transaction price band. As discussed below, the residential index valuation server 104 may be operative to determine transaction price indices for various transaction price bands based on the residential information that the residential index valuation server 104 receives from the various residential information sources 106-110.

The residential index valuation server 104 may communicate with the residential information sources 106-110 via a network 116. The residential index valuation server 104 may also communicate with the client devices 112-114 via a network 118. The networks 116-118 may be any combination of wired and wireless networks, and may be any combination of private networks, such as Local Area Networks (“LANs”), and public networks, such as the Internet. Although FIG. 1 illustrates that the client devices 112-114 and the residential information sources 106-110 are in communication with a single residential index valuation server 104, the client devices 112-114 and the residential information sources 106-110 may be in communication with multiple residential index valuation servers (not shown) via the networks 116-118. In addition, a single residential index valuation server 104 may include multiple density smoothing servers, and a single client device, such as a client device 112, may include multiple client devices.

FIG. 2 illustrates one example of the residential index valuation server 104. In one embodiment, the residential index valuation server 104 includes a memory 202 in communication with a processor 204. The memory 202 may store a residential transaction database 206, a residential index database 208, and a data sufficiency rules engine 210. Although shown as a single block, the memory 202 and/or the processor 204 may be distributed across multiple servers in multiple locations.

The processor 204 is operative to receive the residential information from the residential information sources 106-110. When the processor 204 receives the residential information, the processor 204 may invoke the data sufficiency rules engine 210 to evaluate the completeness and accuracy of the received residential information.

In one embodiment, the data sufficiency rules engine 210 comprises a plurality of data sufficiency rules 218-222 for evaluating the data sufficiency of the received residential information. The data sufficiency rules engine 210 may define many different types of data sufficiency rules 218-222. One type of data sufficiency rule may categorize the residential information source. For example, the data sufficiency rules engine 210 may comprise a data sufficiency rule, such as data sufficiency rule 218, that categorizes an anonymous Internet user as a non-authoritative source of residential information. As another example, the data sufficiency rules engine 210 may comprise a data sufficiency rule, such as data sufficiency rule 218, that categorizes a governmental (local, state, federal, etc.) source of residential information as an authoritative source of residential information. Hence, for each residential information source 106-110 that the residential index valuation server 104 communicates with, the data sufficiency rules engine 210 may include a data sufficiency rule 218-222 that categorizes the type of the residential information source.

Another type of data sufficiency rule may include a mapping of the received residential information to one or more fields of a residential transaction record of the residential transaction database 206. In one embodiment, the residential transaction database 206 is operative to store one or more residential transaction records 212-216 that store residential information for corresponding residential transactions. An individual residential transaction record, such as residential transaction record 212, may correspond to an individual transaction. Alternatively, an individual residential transaction record, such as residential transaction record 214, may correspond to one or more residential transactions.

The residential transaction records may have one or more residential transaction record fields for storing residential information, which, as discussed above, may encompass demographic information, census information, geographic information, or other types of residential information. Moreover, the residential transaction record fields may be based on the types of residential information received from the various sources 106-110 of residential information. For example, the residential transaction record fields may be based on the types of residential information provided by DataQuick, CoreLogic, or combinations thereof.

Table 1 and Table 2 below lists and describes exemplary residential transaction record fields for a residential transaction record. Table 1 includes residential transaction record fields relating to characteristics of the residence. Table 2 includes residential transaction record fields relating to transactions, such as a sale, purchase, mortgage, etc. involving the residence. It should be understood that neither Table 1 nor Table 2 are exhaustive and that a residential transaction record may include residential transaction record fields shown in Table 1, Table 2, or combinations thereof.

TABLE 1

| Residential Transaction | |
|---|---|
| Record Field | Description |
| FIPS State Code | Federal Information Processing Code |
| | for the State. |
| FIPS Muni Code | Federal Information Processing Code |
| | for the County. |
| FIPS County Name | The FIPS county name. |
| Jurisdiction Name | The name of the reporting |
| | jurisdiction. In CT, MA and RI this |
| | will be the township, not the |
| | county. In certain Independent |
| | cities in VA it will be the |
| | independent city name. |
| Parcel Number | The assessor's parcel number (APN) |
| | or other identifier. |
| Alternate Parcel Number | Pointer to an alternate parcel |
| | number, such as the mobile home |
| | parcel number for the land parcel. |
| Owner | The full unparsed primary owner's |
| | name. |
| Owner 1 First Name | Primary owner's first name. |
| Owner 1 Last Name | The primary owner's last name. |
| Owner 1 Middle Name | The primary owner's middle initial. |
| Owner 1 Suffix | The primary owner's suffix (Jr. III, |
| | etc.). |
| Owner 1 Spouse First | The primary owner's spouse's first |
| Name | name. |
| Owner 1 Spouse Middle | The primary owner's spouse's middle |
| Name | initial. |
| Owner 1 Spouse Suffix | The primary owner's spouse's suffix |
| | (Jr. III, etc.). |
| Owner 1 Et Al or Et Ux | Indicates remark. |
| Owner 1 Group | Indicates if there exist additional |
| | primary owners (after spouse). |
| Owner 1 Trust Flag | Indicates if owner name is a trust. |
| Owner 1 Type | Indicates the primary owner type. |
| Owner 2 | The full unparsed name of second |
| | owner's name. |
| Owner 2 First Name | The second owner's first name. |
| Owner 2 Last Name | The second owner's last name. |
| Owner 2 Middle Name | The second owner's middle initial. |
| Owner 2 Suffix | The second owner's suffix (Jr. III, |
| | etc.). |
| Owner 2 Spouse First | The second owner's spouse's first |
| Name | name. |
| Owner 2 Spouse Middle | The second owners' spouse's middle |
| Name | initial. |
| Owner 2 Spouse Suffix | The secondary owner's spouse's |
| | suffix (Jr. III, etc.). |
| Owner 2 Et Al or Et Ux | Indicates remark. |
| Owner 2 Group | Indicates if there exist additional |
| | secondary owners (after spouse). |
| Owner 2 Trust Flag | Indicates if the second owner's name |
| | is a trust. |
| Owner 2 Type | Indicates the secondary owner type. |
| Ownership Vesting | Indicates ownership status. |
| Company Name Flag | Indicates if the property is owned |
| | by a business entity. |
| Site House Number | The site house number. |
| Site Fraction | The site fraction number (½. etc.) |
| Site Direction | The site pre direction. |
| Site Street Name | The site street name. |
| Site Suffix | The site street suffix (Ave, Dr, Ct, |
| | etc.). |
| Site Post Dir | The site post direction (N, S, E, W |
| | NE, etc.). |
| Site Unit Prefix | The site unit number prefix. |
| Site Unit | The site unit number. |
| Site City State | The site city and state. |
| Site Zip | The site ZIP. |
| Site Carrier Route | The site postal carrier route. |
| Site Plus 4 | The site address ZIP plus 4. |
| Mail House Number | The house number. |
| Mail Fraction | The house number fraction (½, |
| | etc.). |
| Mail Direction | The mail pre-directional. |
| Mail Street Name | The mail street name. |
| Mail Suffix | The mail suffix. |
| Mail Post Dir | The mail post directional. |
| Mail Unit Prefix | The mail unit number prefix (Suite, |
| | Apt. Unit). |
| Mail Unit | The mail unit number, free form. |
| Mail City State | The mail city and state. |
| Mail State | The mail state. |
| Mail Zip | The mail ZIP. |
| Mail Plus 4 | The mail address Zip plus 4. |
| Mail Carrier Route | The Postal Carrier Route. |
| | Identifies a single postal carrier's |
| | assigned mail route. |
| Site Mail Same Flag | Indicates if the site and mail |
| | address are the same, Owner |
| | Occupied. |
| Assessor Legal | The assessor's description of |
| Description | property location. |
| Lot Number 1 | The primary or first lot. Part of |
| | the legal description of a property. |
| | Usually refers to a portion of the |
| | subdivision. |
| Lot Number 2 | The second lot. Part of the legal |
| | description of a property. Usually |
| | refers to a portion of the |
| | subdivision. |
| Lot Number 3 | The third lot. Part of the legal |
| | description of a property. Usually |
| | refers to a portion of the |
| | subdivision. |
| Block Number 1 | The primary or first block. |
| Block Number 2 | The second block. |
| Subdivision Name | Information on the property |
| | developer subdivision tract. |
| Section | A division or parcel of land on |
| | government survey, comprising one |
| | square mile (640 acres). |
| Township | A territorial division of land |
| | established by federal survey, being |
| | six miles square and containing |
| | thirty-six sections, each one square |
| | mile. |
| Quarter | Identifies one quarter section. A |
| | quarter section contains 160 acres. |
| | AKA Quarter Section. |
| Range | A division of land in the government |
| | survey, being a six mile wide row of |
| | townships, running North and South, |
| | and used in legal descriptions. AKA |
| | Quarter-Quarter Section. |
| TB Map Grid New | The TB Map Grid New. |
| TB Map Page New | The TB Map Page New |
| Filler | Filler. |
| County Use Code | County Specific Use Code. |
| Zoned County Code | The county zone code. |
| Assessment Year | The year of the represented assessed |
| | value. |
| Tax Exemption Flag - | Indicates a “homeowner” tax |
| Homeowners | exemption. |
| Tax Exemption Flag - | Indicates a “disabled” tax |
| Disabled | exemption. |
| Tax Exemption Flag - | Indicates a “senior” tax exemption. |
| Senior | |
| Tax Exemption Flag - | Indicates a “veteran” tax exemption. |
| Veteran | |
| Tax Exemption Flag - | Indicates a “widow” tax exemption. |
| Widow | |
| Tax Exemption Flag - | Indicates an “other” tax exemption. |
| other | |
| Tax Exemption Amount - | The “homeowner” tax exemption |
| Homeowners | amount. |
| Tax Exemption Amount - | The “disabled” tax exemption amount. |
| Disabled | |
| Tax Exemption Amount - | The “senior” tax exemption amount. |
| Senior | |
| Tax Exemption Amount - | The “veteran” tax exemption amount. |
| Veteran | |
| Tax Exemption Amount - | The “widow” tax exemption amount. |
| Widow | |
| Tax Exemption Amount - | The “other” tax exemption amount. |
| Other | |
| Assessed Value | The gross assessed value (structures |
| | and land). |
| Assessed Improvement | The improved value of structures. |
| Value | |
| Assessed Land Value | The improved value of land. |
| Assessor Percent | The percent of total assessed value |
| Improvement | represented by improvements. |
| Assessor Market Value | The market value used by the |
| | assessor to determine assessed |
| | value. |
| Assessor Market | The market improvement value. |
| Improvement Value | |
| Assessor Market Land | The market improved of land. |
| Value | |
| Assessor Market Percent | The percent of total market value |
| Improvement | represented by improvements. |
| Assessor Appraised Value | The appraised value of a property |
| | for assessment purposes. |
| Assessor Appraised | The appraised improvement value. |
| Improvement Value | |
| Assessor Appraised Land | The appraised improvement value of |
| Value | land. |
| Assessor Appraised | The percent of total appraised value |
| Percent Improvement | represented by improvements. |
| Assessor Full Cash Value | The full cash value. |
| Value Current Limit | The maximum property value increase |
| | amount involved in the calculation |
| | of property tax. |
| The Tax Year | The year of the represented taxes. |
| Tax Amount Paid | The annual property tax paid. |
| Tax Year Delinquent | The year of the property taxes that |
| | became delinquent. |
| Year Built | The year in which property was |
| | constructed. |
| Effective Year Built | The year in which major improvements |
| | were made. |
| Building Shape Code | Indicates the shape of the building. |
| Architecture Code | Indicates the architectural style of |
| | the structure. |
| Structure Code | Indicates the structural style or |
| | the presence of specific elements of |
| | style. |
| Exterior Code 1 | Indicates the exterior construction |
| | material. |
| Exterior Code 2 | Indicates the exterior construction |
| | material (supplemental). |
| Construction Code | Indicates the type of building |
| | construction. |
| Construction Quality | Indicates the construction quality. |
| Lot Depth | The number of feet for the depth of |
| | the property. |
| Lot Width | The number of feet at the front of |
| | the property. |
| Lot Size | Lot size expressed in square feet. |
| Total Square Feet Raw | Assessor provided building square |
| | feet (raw). |
| Finished Square Feet | Total living and/or heated/air |
| Total | conditioned area in square feet. |
| Finished Square Feet | Numeric Indicator of the finished |
| Type | square feet type (1-4). |
| Finished Square Feet 1 | Finished square feet, floor/area 1. |
| | Generally, the first non-basement |
| | floor/area (aka ground floor). |
| Finished Square Feet 2 | Finished square feet, floor/area 2 |
| | (aka 2nd floor). |
| Finished Square Feet 3 | Finished square feet, floor/area 3 |
| | (aka 3rd floor). |
| Finished Square Feet 4 | Finished square feet, floor/area 4 |
| | (aka 4th floor). |
| Total Finished Square | Assessor provided living area square |
| Feet Raw | feet (raw). |
| Additions Square Feet | Identified additions square feet. |
| Attic Total Square Feet | Attic total square feet. |
| Basement Finished Square | Finished basement square feet. |
| Feet | |
| Basement Unfinished | Unfinished basement square feet. |
| Square Feet | |
| Garage Square Feet 1 | Indicates the total square footage |
| | of the primary garage. |
| Garage Square Feet 2 | Indicates the total square footage |
| | of the secondary garage. |
| Heating Cooling | Indicates the presence of heating, |
| | cooling or both. |
| Heating Detail | Method or system of heating. |
| Cooling Detail | Method or system of cooling. |
| Fireplace Code | Indicates the presence of a |
| | fireplace, the type of construction, |
| | or brief description. |
| Garage Carport | Indicates the presence of a garage |
| | or carport, if it is attached or |
| | detached and the number of spaces. |
| Number Of Baths | The number of bathrooms. |
| Number of Baths | The standard real estate definition |
| | of the number of bathrooms |
| Quarter Baths | The number of one-quarter baths. A |
| | one-quarter bath is typically |
| | defined as only having a toilet |
| Half Baths | The number of one-half baths. A one- |
| | half bath is typically defined as |
| | having only a toilet and a sink |
| Three-Quarter Baths | The number of three-quarters baths. |
| | A three-quarters bath is typically |
| | defined as having only a toilet, |
| | sink and shower |
| Full Baths | The number of full baths. A full |
| | bath is typically defined as having |
| | a toilet, sink, shower and bathtub. |
| Number Of Bedrooms | The number of bedrooms. |
| Number Of Rooms | Total number of rooms |
| Number Of Stories | The number of stories. |
| Number Of Units | The number of units on the property. |
| Pool Code | Indicates the presence or type of |
| | pool. |
| Pool SQFT | The pool square footage. |
| Roof Code | Indicates the roof type. |
| View Code | Indicates the presence of a view at |
| | the property. |
| Transaction ID | The unique transaction identifier. |
| Recorder Thru Date | The most current document date keyed |
| | in a jurisdiction. |
| Document Date 1 | The document date for the |
| | transaction. |
| Transfer Value | The transfer value of the property, |
| | AKA sale amount or sale value. |
| Buyer Name | The buyer name. |
| Seller Name | The seller name. |
| Arms Length Transaction | Indicates an arms length |
| Flag | transaction. |
| Document Type | Indicates the type of document |
| | recorded (deed). |
| Transaction Type | Indicates the transaction type. |
| Full or Partial Code | Indicates if the transaction was a |
| | Full or Partial sale. |
| Seller Carryback Flag | Indicates the presence of a seller |
| | carryback. |
| Multiple APN Keyed Flag | Indicates multiple parcel numbers |
| | keyed from the document. |
| Loan Amount 1 | The amount of the transaction's |
| | first loan. |
| Loan Amount 2 | The amount of the transaction's |
| | second loan (concurrent). |
| Loan Amount 3 | The amount of the transaction's |
| | third loan (concurrent). |
| Document Number 1 | If purchase transaction, the Grant |
| | Deed document number. If Grant Deed |
| | exists with concurrent Trust Deed(s) |
| | then DOCUMENT NUMBER 2 through |
| | 4 are also populated (where |
| | applicable). |
| | If non-purchase, the Trust Deed |
| | document number. |
| Document Number 2 | The document number for 1st TD on |
| | purchase transaction. |
| Document Number 3 | The document number for concurrent |
| | 2nd TD on a purchase transaction. |
| Document Number 4 | The document number for concurrent |
| | 3rd TD on a purchase transaction. |
| Lender Code 1 | The lender code for the |
| | transaction's first loan. |
| Lender Code 2 | The lender code for the |
| | transaction’s second loan |
| | (concurrent). |
| Lender Code 3 | The lender code for the |
| | transaction's third loan |
| | (concurrent). |
| Lender First Name 1 | The lender first name of the |
| | transaction's first loan. |
| Lender Last Name 1 | The lender last name of the |
| | transaction's first loan. |
| Lender First Name 2 | The lender first name of the |
| | transaction's second loan |
| | (concurrent). |
| Lender Last Name 2 | The lender last name of the |
| | transaction's second loan |
| | (concurrent). |
| Lender First Name 3 | The lender first name of the |
| | transaction's third loan |
| | (concurrent). |
| Lender Last Name 3 | The lender last name of the |
| | transaction's third loan |
| | (concurrent). |
| Lender Credit Line 1 | Indicates if the transaction's first |
| | loan is a credit line as keyed from |
| | a deed of trust. |
| Lender Credit Line 2 | Indicates if the transaction's |
| | second loan (concurrent) is a credit |
| | line as keyed from a deed of trust. |
| Lender Credit Line 3 | Indicates if the transaction's third |
| | loan (concurrent) is a credit line |
| | as keyed from deed of trust. |
| Loan Type 1 | Indicates the loan type of the |
| | transaction's first loan. |
| Loan Type 2 | Indicates the loan type of |
| | transaction's second loan |
| | (concurrent). |
| Loan Type 3 | Indicates the loan type of the |
| | transaction's third loan |
| | (concurrent). |
| Interest Rate Type 1 | The type of interest rate for the |
| | transaction's first loan. |
| Interest Rate Type 2 | The type of interest rate for the |
| | transaction's second loan |
| | (concurrent). |
| Interest Rate Type 3 | The type of interest rate for the |
| | transaction's third loan |
| | (concurrent). |
| Escrow Id | Indicates the escrow/closing |
| | identification number of the |
| | transaction. |
| Title Company Code | The title company code. |
| Title Company Name | The title company name. |
| Title Id | Indicates the title identification |
| | number of the transaction. Often |
| | handwritten. |

TABLE 2

| Residential Transaction | |
|---|---|
| Record Field | Description |
| Transfer Value | The transfer value of the property, |
| | AKA sale amount or sale value. |
| Buyer Name | The buyer name. |
| Seller Name | The seller name. |
| Arms Length Transaction | Indicates an arms length |
| Flag | transaction. |
| Document Type | Indicates the type of document |
| | recorded (deed). |
| Transaction Type | Indicates the transaction type. |
| Quit Claim Flag | Identifies Quit Claim transactions |
| Full or Partial Code | Indicates if the transaction was a |
| | Full or Partial sale. |
| Seller Carryback Flag | Indicates the presence of a seller |
| | carryback. |
| Multiple APN Keyed Flag | Indicates multiple parcel numbers |
| | keyed from the document. |
| Loan Amount 1 | The amount of the transaction's |
| | first loan. |
| Loan Amount 2 | The amount of the transaction's |
| | second loan (concurrent). |
| Loan Amount 3 | The amount of the transaction's |
| | third loan (concurrent). |
| Document Number 1 | If purchase transaction, the Grant |
| | Deed document number. If Grant Deed |
| | exists with concurrent Trust Deed(s) |
| | then DOCUMENT NUMBER 2 through 4 |
| | are also populated (where applicable). |
| | If non-purchase, the Trust Deed |
| | document number. |
| Document Number 2 | The document number for 1st TD on |
| | purchase transaction. |
| Document Number 3 | The document number for concurrent |
| | 2nd TD on a purchase transaction. |
| Document Number 4 | The document number for concurrent |
| | 3rd TD on a purchase transaction. |
| Lender Code 1 | The lender code for the |
| | transaction's first loan. |
| Lender Code 2 | The lender code for the |
| | transaction's second loan |
| | (concurrent). |
| Lender Code 3 | The lender code for the |
| | transaction's third loan |
| | (concurrent). |
| Lender First Name 1 | The lender first name of the |
| | transaction's first loan. |
| Lender Last Name 1 | The lender last name of the |
| | transaction's first loan. |
| Lender First Name 2 | The lender first name of the |
| | transaction's second loan |
| | (concurrent). |
| Lender Last Name 2 | The lender last name of the |
| | transaction's second loan |
| | (concurrent). |
| Lender First Name 3 | The lender first name of the |
| | transaction's third loan |
| | (concurrent). |
| Lender Last Name 3 | The lender last name of the |
| | transaction's third loan |
| | (concurrent). |
| Lender Credit Line 1 | Indicates if the transaction's first |
| | loan is a credit line as keyed from |
| | a deed of trust. |
| Lender Credit Line 2 | Indicates if the transaction's |
| | second loan (concurrent) is a credit |
| | line as keyed from a deed of trust. |
| Lender Credit Line 3 | Indicates if the transaction's third |
| | loan (concurrent) is a credit line |
| | as keyed from deed of trust. |
| Loan Type 1 | Indicates the loan type of the |
| | transaction's first loan. |
| Loan Type 2 | Indicates the loan type of |
| | transaction's second loan |
| | (concurrent). |
| Loan Type 3 | Indicates the loan type of the |
| | transaction's third loan |
| | (concurrent). |
| Interest Rate Type 1 | The type of interest rate for the |
| | transaction's first loan. |
| Interest Rate Type 2 | The type of interest rate for the |
| | transaction's second loan |
| | (concurrent). |
| Interest Rate Type 3 | The type of interest rate for the |
| | transaction's third loan |
| | (concurrent). |
| Escrow Id | Indicates the escrow/closing |
| | identification number of the |
| | transaction. |
| Title Company Code | The title company code. |
| Title Company Name | The title company name. |
| Title Id | Indicates the title identification |
| | number of the transaction. Often |
| | handwritten. |
| Process ID | The process sequence identification |
| | number. |
| REO Flag | For Trustees Deeds, flags bank (B) |
| | and government (G) buyers. |

As shown in Table 1 and Table 2, it is possible that a residential transaction record have a number of residential transaction record fields. However, it is also possible that the residential information received from a residential information source does not directly correspond to the residential transaction record fields. One data sufficiency rule may include a mapping that describes how the processor 204 should store the residential information received from a residential information source to a residential transaction record field. Moreover, different data sufficiency rules may have different mappings. For example, a data sufficiency rule that maps residential information received from a governmental source located in New Jersey may have a different mapping than a data sufficiency rule that maps residential information received from a governmental source located in North Carolina. Accordingly, one or more of the data sufficiency rules 218-222 may be configured to account for potential differences in the way residential information is reported by the various residential information sources 106-110.

In one embodiment, when the processor 204 receives the residential information and the data sufficiency rules engine 210 initially evaluates the received residential information, such as by categorizing the type of source providing the residential information and mapping the residential information to one or more residential transaction record fields for storing in the one or more residential transaction records 212-216, the processor 204 may then invoke the data sufficiency rules engine 210 to determine whether the amount of provided residential information is relatively complete for a given transaction.

In one embodiment, the data sufficiency rules engine 210 may include one or more data sufficiency rules 218-222 that comprise an evaluation of whether a selected one of the plurality of residential transaction records 212-216 comprises complete residential transaction information. A data sufficiency rule may specify the amount of residential information a residential transaction record should have in order to consider the residential transaction record complete. In one embodiment, this amount of residential information may be a minimum set of residential information. For example, a data sufficiency rule may specify that a residential transaction record should have, at a minimum, a transaction price, a lot number, and a square footage. When the data sufficiency rules engine 210 evaluates a residential transaction record having this minimum set of residential information, the data sufficiency rules engine 210 may consider the residential transaction record complete.

In another embodiment, the data sufficiency rules 218-222 may define a minimum set of residential information a residential transaction record should have and a set of residential information a residential transaction record should have to be considered complete. A complete set of residential information may be different than a minimum set of residential information. For example, the data sufficiency rules engine 210 may evaluate a residential transaction record as having a minimum set of residential information when the residential transaction record has a lot number, a transaction price, a street address, and a ZIP code, but missing other residential information, such as the number of bathrooms, the number of bedrooms, or any of the other residential information identified in Table 1, Table 2, or a combination of Table 1 and Table 2. The data sufficiency rules 210 may evaluate a residential transaction record as having a complete set of residential information when the residential transaction record has information for a predetermined set of residential transaction record fields, such as a lot number, a transaction price, a street address, a ZIP code, a number of bathrooms, and a number of bedrooms.

Moreover, different sets of residential information may be defined as complete or minimum depending on the state in which the residence is located. For example, a minimum set of residential information for a residence located in Georgia may be different than the minimum set of residential information for a residence located in New Jersey. Similarly, a complete set of residential information for a residence located in Georgia may be different than a complete set of residential information for a residence located in New Jersey. In addition, it is possible that a minimum set of residential information for a residence in one location is the same as a complete set of residential information for a residence in another location.

The data sufficiency rules engine 210 may also evaluate whether one or more residential transaction records 212-216 should be further populated with residential information based on whether the residential transaction record has a minimum set of residential information and the type of residential information source that provided the residential information. Depending on whether the type of residential information source was authoritative or not, the data sufficiency rules engine 210 may notify the processor 204 to further populate a selected residential transaction record. Table 3 below lists the actions the processor 204 may perform depending on whether the residential transaction record has the minimum set of residential information, a complete set of residential information, and whether the residential information sources available to further populate the residential transaction record are authoritative or not.

TABLE 3

| Amount of Residential | | Initial Source | |
|---|---|---|---|
| Information in Record | | Authoritative | Suggested Action |
| Minimum Set | Complete | — | — |
| No | No | No | Attempt to populate |
| | | | record with residential |
| | | | information from |
| | | | authoritative |
| | | | source(s). |
| No | No | Yes | Identify record as |
| | | | lacking minimum set of |
| | | | residential |
| | | | information. |
| Yes | No | No | Attempt to verify |
| | | | whether residential |
| | | | information is accurate |
| | | | with authoritative |
| | | | source(s). Attempt to |
| | | | complete record with |
| | | | residential information |
| | | | from authoritative |
| | | | source(s). |
| Yes | No | Yes | Identify record as |
| | | | having minimum set of |
| | | | residential |
| | | | information. |
| Yes | Yes | No | Attempt to verify |
| | | | whether residential |
| | | | information is accurate |
| | | | with authoritative |
| | | | source(s). |
| Yes | Yes | Yes | Identify record as |
| | | | having complete set of |
| | | | residential |
| | | | information. |

As shown above in Table 3, there may be instances where the residential index valuation server 104 may attempt to verify whether received residential information is accurate, such as where the initial residential information source was non-authoritative, or may attempt to populate a residential information transaction record with residential information from an authoritative source, such as where the residential transaction record is incomplete and the initial residential information source was non-authoritative. Should the attempt by the residential index valuation server 104 fail in the verification or further population of the residential transaction record, the processor 204 may note this failure as part of the residential transaction record or in a separate log maintained by the residential valuation server 104.

Once the data sufficiency engine 210 is satisfied with the completeness and/or accuracy of the residential transaction records 212-216, even if not all of the residential transaction records are complete, the processor 204 may then turn to aggregating the residential transaction records 212-216 into one or more transaction price bands. In general, a transaction price band represents a group of residences that may have similar characteristics, such as in square footage, pricing, geographic location, or other characteristic. A transaction price band may have an upper transaction price band limit and a lower transaction price band limit such that residences assigned to the transaction price band have transaction prices on or between these limits.

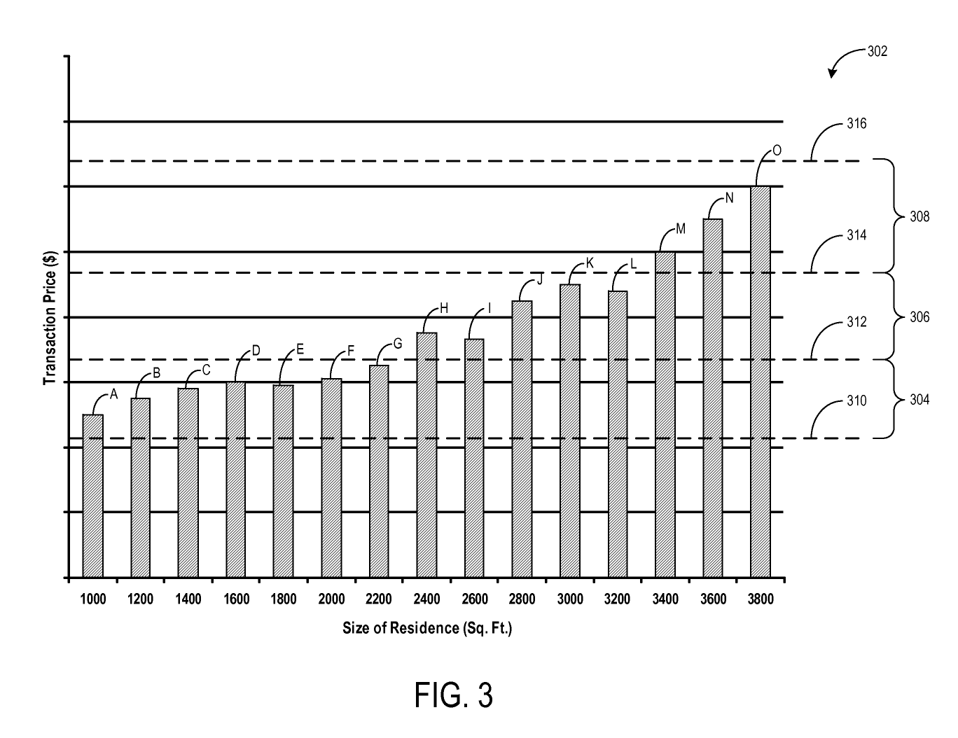

FIG. 3 illustrates one example of aggregating residential transaction price records A-O into several different transaction price bands 304-308. The graph 302 in FIG. 3 illustrates that the processor 204 has aggregated various transaction records A-O having increasing transaction prices into three transaction price bands 304-308, which include a lower transaction price band 304, a middle transaction price band 306, and an upper transaction price band 310.

Each of the transaction price bands 304-308 may have an upper transaction price band limit and a lower transaction price band limit. In addition, the upper transaction price band limit for one transaction price band may be the lower transaction price band limit for another transaction price band. For example, the lower transaction price band 304 may have a lower transaction price band limit 310 and an upper transaction price band limit 312, where the upper transaction price band limit 312 is a lower transaction price band limit 312 for the middle transaction price band 306. Although FIG. 3 shows that the residential transaction records A-O have been aggregated into three transaction price bands 304-308, it should be understood that, depending on the scheme used by the processor 204 in aggregating the transaction price records A-O, the processor 204 may aggregate the transaction price records A-O in different (e.g., fewer or more) transaction price bands.

In one embodiment, the processor 204 may initially aggregate the residential transaction records A-O based on the residences' geographic location at various granularities. For example, the processor 204 may aggregate the residential transaction records A-O according to the 9-digit ZIP code assigned to the residences, which may be stored in the residential transaction record for the corresponding residence. Alternatively, the processor 204 may aggregate the residential transaction records A-O according to a 5-digit ZIP code or with other geographic location information, such as by town/city, street address, etc.

The processor 204 may then select one or more residential characteristics by which to aggregate the residential transaction records for a given geographic location. Residential characteristics include, but are not limited to, the square footage of the residence, the transaction price, the number of bedrooms for a given residence, the number of bathrooms for a given residence, the quality of assigned public elementary schools, the quality of assigned public high schools, the average income for a geographic location, the potential mortgage for a given residence, or any other residential characteristic. A residential characteristic may also include any one of the fields previously described with regard to Table 1 and Table 2.

The processor 204 may also refer to one or more residential transaction record fields in aggregating the residential transaction records. As shown in FIG. 3, the processor 204 may aggregate the residential transaction records A-O according to the transaction price of the residence and the size of the residence. However, the processor 204 may further aggregate the residential transaction records A-O according to other, or even additional, residential characteristics.

In yet a further embodiment, the processor 204 may aggregate the residential transaction records A-O based on a reference residence or a given transaction. For example, the processor 204 may select or be given a reference residence and then determine comparable residences based on the reference residence, such as the square footage, the number of bedrooms, the geographic location, the average income of the geographic area of the reference residence, or any other characteristic of the reference residence.

The graph 302 of FIG. 3 illustrates that as the square footage of the residences corresponding to the residential transaction records A-O increase in size from approximately 1000 square feet to approximately 3800 square feet, the corresponding transaction prices for the residences generally increase. However, it is possible that during the aggregation of the residential transaction records that the processor 204 encounter outliers or transactions for residential transaction records that would stand out within one or more transaction price bands. For example, in aggregating the residential transaction records according to square footage, the processor 204 may include a residence having a square footage of 1500 square feet in the lower transaction price band 304, but the 1500-square foot residence may have a transaction price that greatly exceeds or significantly falls below the transaction prices for comparatively priced residences, or greatly exceeds or significantly falls below the average transaction price for the residences with the lower transaction price band 304. The processor 204 may determine that the transaction is an outlier by comparing the transaction price with a threshold, such as two standard deviations above the average transaction price for the lower transaction band 304.

The processor 204 may take a variety of actions when an outlier transaction is identified. In one embodiment, the processor 204 may exclude the transaction from the transaction price band. Excluding the transaction from the transaction price band may ensure that the transaction price index for the corresponding transaction price band is not artificially inflated or deflated. In another embodiment, the processor 204 may shift the residential transaction record to another price band. For example, with reference to FIG. 3, should the outlying residential transaction record occur in the lower transaction price band 304 and have an associated transaction price that greatly exceeds a given threshold, such as two standard deviations above the average transaction prices for the transaction price band 304, the processor 204 may shift the outlying residential transaction record to the middle transaction price band 306 or the upper transaction price band 308, depending on whether the processor 204 determines that the outlying transaction price is more commensurate with transaction prices in the middle transaction price band 306 or the upper transaction price band 308. In yet another embodiment, the processor 204 may attempt to verify that the residential transaction record is, in fact, an outlier by attempting to verify the residential transaction price of the residence with an authoritative residential information source. The processor 204 may also alert a user or administrator of the residential index valuation server 104 to confirm whether the outlying residential transaction record should be included in the transaction price band.

After aggregating the transaction price records A-O into one or more transaction price bands 304-308, the processor 204 may then determine an average transaction price for each of the transaction price bands 304-308. In determine an average transaction price, the processor 204 may determine whether it is a statistically significant number of transactions for a transaction price band to determine the average transaction price for that transaction price band. For example, as shown in FIG. 3, the processor 204 has aggregated seven transactions into the lowest transaction price band 304. Under other circumstances, the processor 204 may aggregate a different number of transactions, such as hundreds or thousands of transactions, into a given transaction price band. The processor 204 may compare the number of aggregated transactions with a determined threshold to determine whether there are a statistically significant number of transactions for the transaction price band.

In one embodiment, the determined threshold may be previously determined or established by a user of the residential index valuation server 104. In addition, the determined threshold may be established for each of the transaction price bands. In another embodiment, the residential index valuation server 104 may determine the threshold through statistical analysis. For example, based on the number of transactions for a given time period, such as three months, six weeks, or other time period, the residential index valuation server 104 may determine whether there is a statistically significant number of transactions for the given transaction price band.

In the event that the processor 204 determines that a given transaction price band does not contain a statistically significant number of transactions, the processor 204 may artificially increase the number of transactions for that given transaction price band. In one embodiment, artificially increasing the number of transactions for the given transaction price band may include expanding the transaction price band limits on the transaction price band. For example, assume that the transaction price band in question is the middle transaction price band 306. In this example, should the processor 204 determine that the middle transaction price band 306 does not contain enough transactions, the processor 204 may increase the upper price band limit 314 and decrease the lower price band limit 312, thus capturing those transactions that may have been aggregated into the upper transaction price band 308 and/or the lower transaction band 304. Moreover, the processor 204 may selectively determine which transaction band limit to increase/decrease. The processor 204 may base its selective determination on which transaction band limit to increase/decrease on such factors as the number of transactions in the adjacent transaction price bands, the characteristics of the residences that would be included in the expanded transaction price band, and other such factors.

The processor 204 may also incorporate additional transactions into the transaction price band without expanding the limits on the transaction price band. For example, the processor 204 may increase the geographic granularity to include nearby transactions. In this example, the processor 204 may include transactions in neighboring ZIP codes involving similarly situated residences (e.g., residences of similar size, cost, etc.). The processor 204 may also consider other transaction characteristics in deciding whether to incorporate a transaction, such as the quality of the assigned public schools, the average income of the geographic location where the transaction occurred, the mortgage amount (if any) for the transaction, the date of the transaction or other such transaction characteristics.

After the transactions have been aggregated into the transaction price band, the processor 204 may then determine an average transaction price for the transaction price band. Thereafter, the processor 204 may determine a transaction price index based on the average transaction price for the transaction price band.

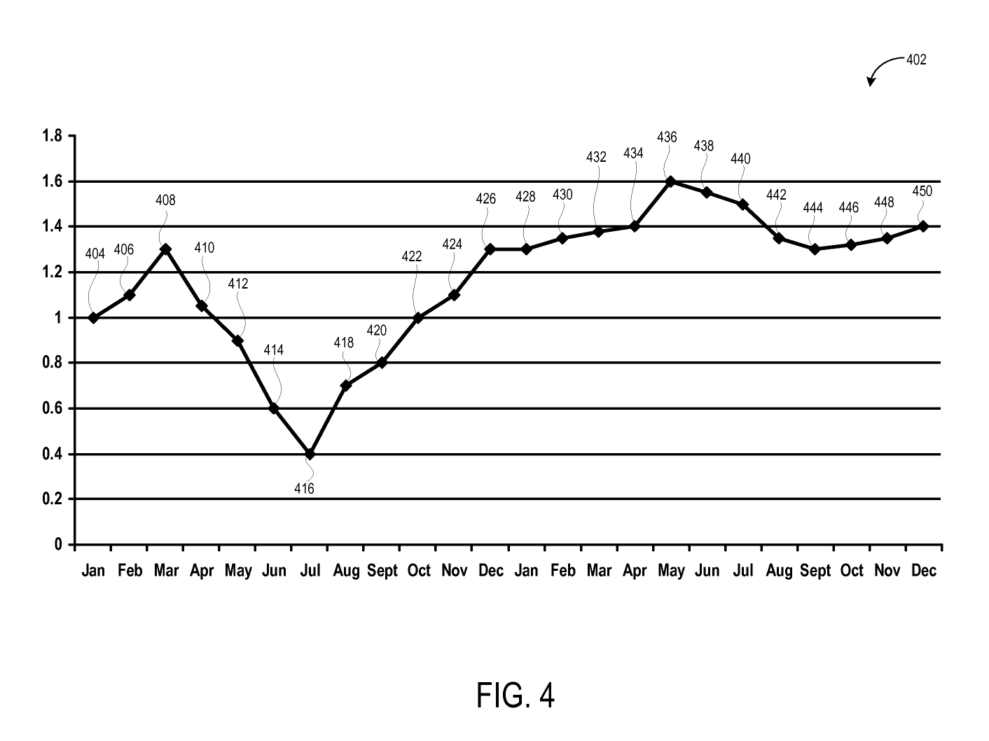

FIG. 4 illustrates one example of a report 402 illustrating transaction price indices 404-450 for a selected transaction price band in accordance with aspects of the disclosure. The transaction price indices 404-450 are illustrative and not intended to reflect any particular set of transaction prices or transaction price band. Moreover, it should be understand that the fluctuation between price indices (e.g., price index 410 and price index 416) is merely to illustrate that a price index may assume a value within a range of values. Although FIG. 4 illustrates an upper limit price index value of about 1.9, and a lower limit price index value of about zero, it should be understood that these limits are merely illustrative for this particular example. In addition, while the transaction price indices 404-450 are shown as varying from about 1.0 to about 1.4 over a course of two years, it should be understood that the illustrated variances are shown for exemplary purposes only and that variances in a transaction price index for a given residence may differ depending on the characteristics of said residence.

In one embodiment, the residential index valuation server 104 determines the transaction price indices 404-450 according to a predetermined time schedule. For example, the residential index valuation server 104 may determine the transaction price indices 404-450 on a monthly schedule. The residential index valuation server 104 may determine a transaction price index for a particular month by dividing the current average transaction price with an initial average transaction price. For example, the residential index valuation server 104 may determine the transaction price index for May, which is approximately equal to 1.4, by dividing the average transaction price of May by the initial average transaction price determined in January, which is equal to 1.0. In this embodiment, the residential index valuation server 104 may determine a transaction price index for a given month at the beginning of the given month or after the predetermined time period has elapsed.

In another embodiment, the residential index valuation server 104 may determine a transaction price index based on when reported transaction data becomes available. For example, each state in the U.S. may have a different reporting schedule for reporting transactions. In this embodiment, the residential index valuation server 104 may determine a transaction price index for a given month based on when the reported transaction data became available. The residential index valuation server 104 may further determine whether the reported transaction data affects the currently determined transaction price index, and, if so, may then determine a transaction price index to reflect the additional reported transaction data. In addition, the residential index valuation server 104 may implement various time schedules for determining transaction price indices based on the reporting schedule of the states. For example, the determination of a transaction price index for one state may occur at a time different than the determination of a transaction price index for a different state.

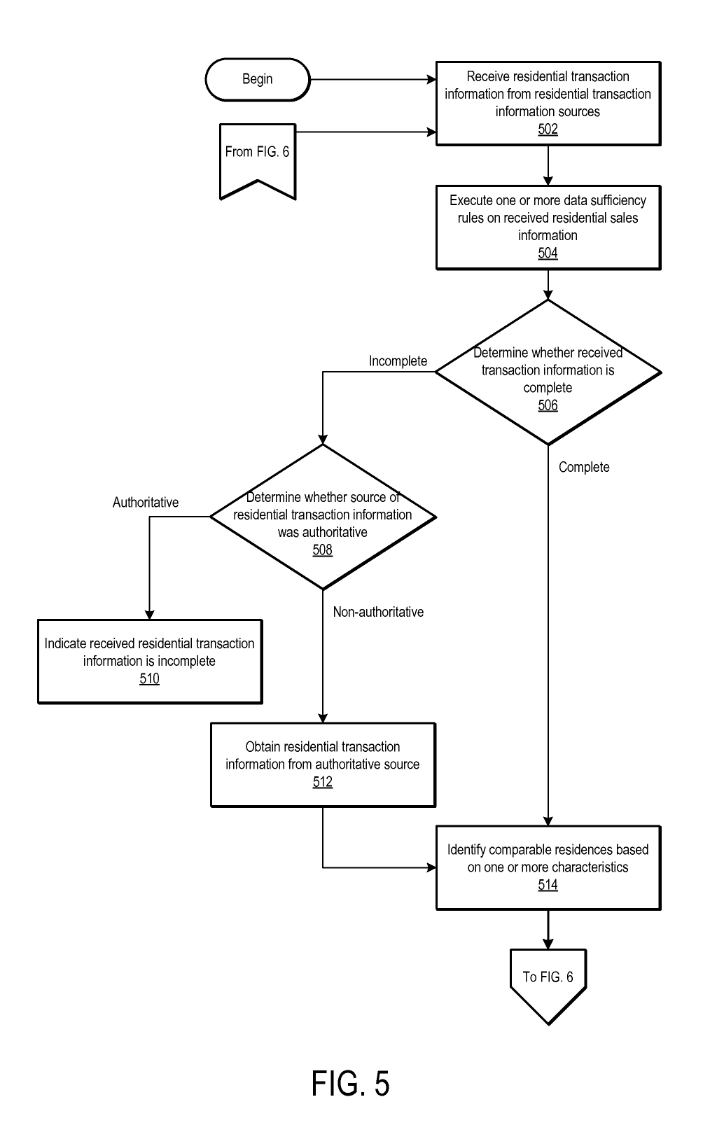

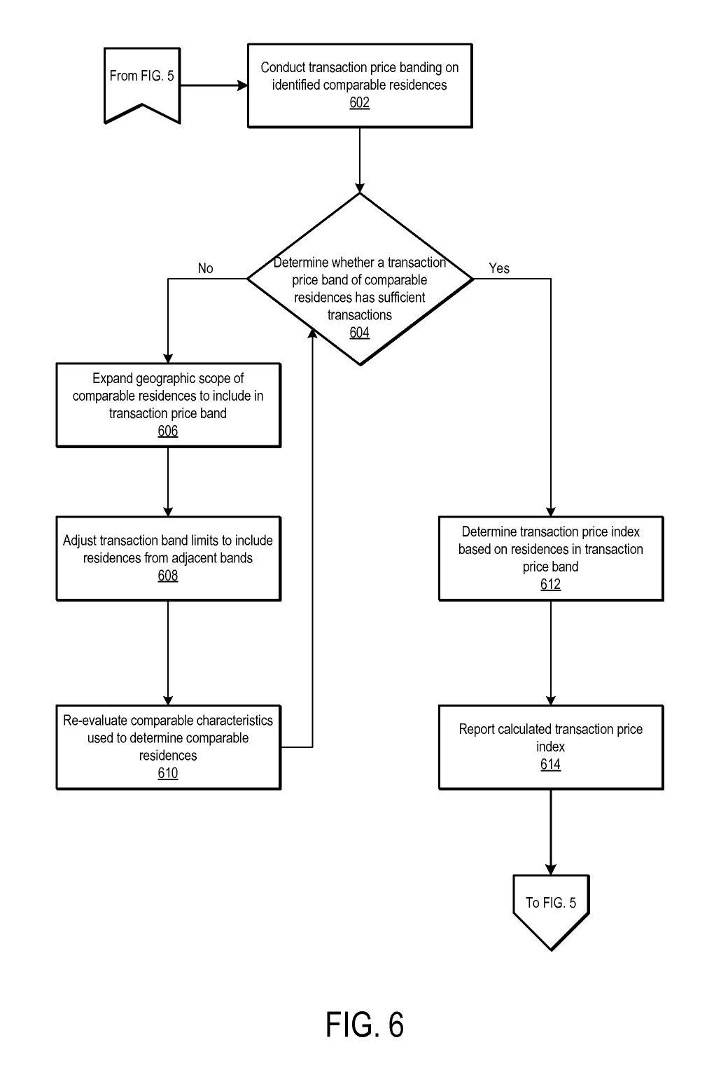

FIGS. 5-6 illustrate logic flow for the residential index valuation server 104. Initially, the residential index valuation server 104 may receive residential transaction information from one or more residential transaction information sources, such as the authoritative and non-authoritative sources discussed earlier (Block 502). The residential index valuations server 104 may then invoke the data sufficiency rules engine 210 to execute one or more data sufficiency rules 218-222 on the received residential transaction information (Block 504).

In one embodiment, the data sufficiency rules 218-222 may define a set of residential transaction information to be complete set of residential transaction information. In this embodiment, the residential index valuation server 104 may determine whether it has received a complete set of transaction information (Block 506). As shown in Table 3, the residential transaction server 104 may take one or more actions based on whether the provided transaction information is complete transaction information. In one embodiment, the residential transaction server 104 may determine whether the transaction source was an authoritative source of transaction information (Block 508).

Should the residential index valuation server 104 determine that the transaction was an authoritative source, but that the provided transaction information was incomplete, the residential index valuation server 104 may indicate that the transaction record for the transaction is incomplete (Block 510). Alternatively, where the transaction source was non-authoritative, the residential index valuation server 104 may attempt to obtain additional transaction information from an authoritative source to complete the transaction information that the residential index valuation server 104 had already obtained (Block 512).

The residential index valuation server 104 may then aggregate one or more transaction records into transaction price bands. In doing so, the residential index valuation server 104 may first identify comparable residences based on one or more transaction characteristics, such as the size of the residence, the transaction price of the residence, the geographic location of the residence, etc. (Block 514). Referring to FIG. 6, the residential index valuation server 104 may then aggregate comparable residences into one or more transaction price bands (Block 602).

After aggregating the transaction records into transaction price bands, the residential index valuation server 104 may then determine whether a transaction price band has sufficient transactions, or a statistically significant number of transactions, by which to determine a transaction price index (Block 604). In one embodiment, where the residential index valuation server 104 determines that it does not have a sufficient number of transactions for a transaction price band, the residential index valuation server 104 may take a number of actions, such as expanding the geographic scope of comparable resides to include in the transaction price band (Block 606), adjusting one or more transaction price band limits to include additional transactions (Block 608), re-evaluating the transaction records based on additional characteristics (e.g., quality of assigned public schools, average income, etc.) (Block 610), and other such actions. The residential index valuation server 104 may then re-determine whether it has incorporated enough transactions into the transaction price band to determine a transaction price index.

After determining that a given transaction price band has a sufficient number transactions, the residential index valuation server 104 may then determine one or more transaction price indices for the transaction price bands (Block 612). As discussed with reference to FIG. 4, the determination of a transaction price index for a transaction price band may be based on dividing an average transaction price for a given time period by an initial average transaction price. The residential index valuation server 104 may then report the determined transaction price index/indices to one or more of the client devices 112-114 in communication with the residential index valuation server 104 (Block 614).

Since the residential index valuation server 104 uses comparable residences to determine the transaction price indices, the value of a given residence may be more accurately predicted. Rather than attempting to valuate a residence individually, the residential index valuation server 104 focuses on providing a metric based on a prior transactions for similarly situated residences. Hence, when a homeowner or lending institution refers to the transaction price index, the homeowner or lending institution gains a better understanding of the change in value of the residence rather than on merely relying on a change in the price of the residence itself.

An example may help clarify the usage of the residential index valuation server 104 in assessing a valuation of a residence. Initially, the residential index valuation server 104 may collect residential information from one or more of the sources of residential information 106-110. For example, the residential index valuation server 104 may receive residential information from DataQuik, CoreLogic, a university, the United States Census Bureau, or other such sources of residential information. The residential index valuation server 104 may collect residential information about one or more residences within a geographic area, such as a particular ZIP code, a particular city, a particular neighborhood, or other such geographic area.

The residential index valuation server 104 may then evaluate the residential information. The residential index valuation server 104 may evaluate the residential information for accuracy, completeness, validity, etc. The evaluation of the residential information may be performed by the data sufficiency rules engine 210. The data sufficiency rules engine 210 may evaluate the sufficiency of the residential information on a residence-by-residence basis, on a transaction-by-transaction basis, on an alternative basis, or a combination thereof. The evaluation of the sufficiency of the residential information ensures that the residential index valuation server 104 is providing accurate residential transaction price indices. When the data sufficiency rules engine 210 determines that some residential information is deficient (e.g., incomplete, inaccurate, conflicting with similar residential information, originated with a non-authoritative source, etc.), the data sufficiency rules engine 210 may attempt to correct the identified deficiency according to one or more of the data sufficiency rules 218-222.

When the residential index valuation server 104 has established that it has sufficient residential information, the residential index valuation 104 may then proceed to the determination of the residential transaction price indices. Initially, the residential index valuation server 104 may organize residential transactions and/or residences into one or more residential transaction price bands (See FIG. 3). As discussed previously, the residential transaction price bands 304-308 may define groupings of residences having a range of transaction prices, such that the residences are grouped having comparable characteristics. The residential index valuation server 104 may use these groupings to determine an initial average transaction price for the residences within a given grouping. The residential index valuation server may then use this initial average transaction price to determine ongoing transaction price indices for residences within the given grouping.

Moreover, and as discussed above, the residences of a given grouping (i.e., the residences of a transaction price band) may not be static. That is, the residences of a transaction price band may vary depending on various conditions. For example, one condition may be that the number of transactions for a given grouping of residences is below a threshold. In this instance, the residential index valuation server 104 may expand the scope of the criteria used in assigning the residences to their given groupings. For example, the residential index valuation server 104 may expand the geographic scope of the residences such that comparable residences from other ZIP codes are included in a given transaction price band. In this manner, the residential index valuation server 104 can ensure that a sufficient number of

1. An apparatus for determining transaction price indices for corresponding transaction price bands, the apparatus comprising:
a memory operative to store:
a plurality of residential transactions;
a plurality of transaction price indices; and
a plurality of data sufficiency rules for evaluating the data sufficiency of residential transaction information; and
a processor operative to:
receive a plurality of residential transaction information;
evaluate the residential transaction information according to a selected one of the data sufficiency rules;
request additional residential transaction information for a selected one of the residential transactions when the processor determines that a portion of the residential transaction information for the selected residential transaction was received from a non-authoritative source;
populate at least one of the residential transactions from the plurality of residential transactions with the evaluated residential transaction information;
aggregate a selected plurality of the residential transactions into a plurality of transaction price bands according to a plurality of residential comparable characteristics;
determine a transaction price index for a selected one of the plurality of transaction price bands; and
report the transaction price index to a client device when the transaction price index is requested.

2. (canceled)

3. The apparatus of claim 1, wherein a selected one of the residential transactions comprises a selling price for a residence; and
the transaction price index for the selected transaction price band is determined based on the selling price for the residence.

4. The apparatus of claim 1, wherein a selected one of the plurality of the data sufficiency rules comprises an evaluation of whether a selected one of the plurality of residential transactions comprises complete residential transaction information.

5. The apparatus of claim 1, wherein a selected one of the plurality of the data sufficiency rules establishes a minimum set of residential transaction information expected to be received.

6. The apparatus of claim 1, wherein the processor is further operative to:
determine whether the selected transaction price band comprises a threshold number of residential transactions; and
expand a transaction price band limit on the selected transaction price band to include at least one additional residential transaction from another one of the plurality of transaction price bands when the selected transaction price band does not comprise the threshold number of residential transactions.

7. The apparatus of claim 1, wherein the processor is further operative to include additional residential transactions in the selected transaction price band when the selected transaction price band does not comprise a threshold number of residential transactions.

8. The apparatus of claim 7, wherein the processor is further operative to select the additional residential transactions based on expanding a geographic scope used in previously aggregating the residential transactions into the selected transaction price band.

9. The apparatus of claim 1, wherein the residential comparable characteristics comprise at least one of demographic information, residential size, or residential location.

10. The apparatus of claim 1, wherein the processor is further operative to re-determine the transaction price index when the processor receives additional residential transaction information that the processor determines affects the previously determined transaction price index.

11. A computer-implemented method for determining transaction price indices for corresponding transaction price bands, the computer-implemented method comprising:
establishing, in a memory, a plurality of residential transactions;
establishing, in the memory, a plurality of transaction price indices;
establishing, in the memory, a plurality of data sufficiency rules for evaluating the data sufficiency of residential transaction information;
receiving, with a processor in communication with the memory, a plurality of residential transaction information;
evaluating, with the processor, the residential transaction information according to a selected one of the data sufficiency rules;
requesting, with the processor, additional residential transaction information for a selected one of the residential transactions when the processor determines that a portion of the residential transaction information was received from a non-authoritative source;
populating, with the processor at least one of the residential transactions with the evaluated residential transaction information;
aggregating, with the processor, a selected plurality of the residential transactions into a plurality of transaction price bands according to a plurality of residential comparable characteristics;
determining, with the processor, a transaction price index for a selected one of the plurality of transaction price bands; and
reporting, with the processor, the transaction price index to a client device when the transaction price index is requested.

12. (canceled)

13. The method of claim 11, wherein a selected one of the residential transactions comprises a selling price for a residence; and
the transaction price index for the selected transaction price band is determined based on the selling price for the residence.

14. The method of claim 11, wherein a selected one of the plurality of the data sufficiency rules comprises an evaluation of whether a selected one of the plurality of residential transactions comprises complete residential transaction information.

15. The method of claim 11, wherein a selected one of the plurality of the data sufficiency rules establishes a minimum set of residential transaction information expected to be received.

16. The method of claim 11, further comprising:
determining whether the selected transaction price band comprises a threshold number of residential transactions; and
expanding a transaction price band limit on the selected transaction price band to include at least one additional residential transaction from another one of the plurality of transaction price bands when the selected transaction price band does not comprise the threshold number of residential transactions.

17. The method of claim 11, further comprising:
including additional residential transactions in the selected transaction price band when the selected transaction price band does not comprise a threshold number of residential transactions.

18. The method of claim 17, further comprising:
selecting the additional residential transactions based on expanding a geographic scope used in previously aggregating the residential transactions into the selected transaction price band.

19. The method of claim 11, wherein the residential comparable characteristics comprise at least one of demographic information, residential size, or residential location.

20. The method of claim 11, further comprising:
re-determining the transaction price index when additional residential transaction information is received that affects the previously determined transaction price index.

21. An apparatus for determining transaction price indices for a corresponding residence, the apparatus comprising:
a processor operative to:
aggregate a plurality of residential transaction prices into one or more transaction price bands;
determine a first average residential transaction price for a first time period for a selected one of the one or more transaction price bands;
determine a second average residential transaction price for a second time period for the selected one of the one or more transaction price bands;
determine a residential transaction price index for the second time period based on the first average residential transaction price and the second residential transaction price; and
provide the residential transaction price index when a request is received for the residential transaction price index.

22. The apparatus of claim 1, wherein:
a first data sufficiency rule establishes a first mapping between a first residential transaction of the plurality of residential transactions and first residential transaction information of the plurality of residential transaction information, the first mapping based on a first source of the first residential transaction information;
a second data sufficiency rule establishes a second mapping between a second residential transaction of the plurality of residential transactions and second residential transaction information of the plurality of residential transaction information, the second mapping based on a second source of the second residential transaction information;
the first source is different than the second source; and
the first mapping is different than the second mapping.

23. The method of claim 11, further comprising:
performing first mapping, with the processor and based on a first data sufficiency rule, first residential transaction information of the plurality of residential transaction information to a first residential transaction of the plurality of residential transactions, wherein the mapping is based on a first source of the first residential transaction information; and
performing second mapping, with the processor and based on a second data sufficiency rule, second residential transaction information of the plurality of residential transaction information to a second residential transaction of the plurality of residential transactions, wherein the mapping is based on a second source of the second residential transaction information; and wherein:
the first source is different than the second source; and
the first mapping is different than the second mapping.
